(19) United States
(12) Patent Application Publication
(10) Pub. No.: US 2026/0136209 A1
(43) Pub. Date: May 14, 2026

(54) MACHINE LEARNING (ML)-BASED TRANSMISSION MODE CONFIGURATION

(71) Applicant: QUALCOMM Incorporated, San Diego, CA (US)

(72) Inventors: Xiaolong HUANG, Santee, CA (US); Jinsung LEE, San Jose, CA (US); Ahmed Ragab ELSHERIF, San Jose, CA (US); Ashutosh SRIVASTAVA, Sunnyvale, CA (US); Srinivas KATAR, Fremont, CA (US)

(21) Appl. No.: 18/946,692

(22) Filed: Nov. 13, 2024

(51) Int. Cl. H04W 24/02; H04L 5/00

(52) U.S. Cl. CPC H04W 24/02; H04L 5/0007

(57) ABSTRACT

This disclosure provides methods, components, devices and systems for machine learning (ML)-based transmission mode configuration and enablement. An example method, performed at a wireless node, generally includes obtaining information regarding a current transmission scenario, using the information regarding the current transmission scenario as input to a machine learning (ML) model to select a transmission configuration, and processing a transmission based on an output of the ML model.

### TECHNICAL FIELD

This disclosure relates generally to wireless communication, and more specifically, to machine learning (ML)-based transmission mode configuration and enablement.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device (e.g., a wireless station (STA) or wireless access point (AP)). The wireless communication device may perform a method, including obtaining information regarding a current transmission scenario; using the information regarding the current transmission scenario as input to a machine learning (ML) model to select a transmission configuration; and processing a transmission based on an output of the ML model.

One innovative aspect of the subject matter described in this disclosure can be implemented in a method for wireless communication at a wireless node. The method includes obtaining information regarding a current transmission scenario; using the information regarding the current transmission scenario as input to a machine learning (ML) model to select a transmission configuration; and processing a transmission based on an output of the ML model.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a diagram illustrating techniques for ML-based transmission mode configuration and enablement, in accordance with certain aspects of the present disclosure.

FIG. 3 shows a diagram illustrating techniques for ML-based transmission mode configuration and enablement based on a supervised learning framework, in accordance with certain aspects of the present disclosure.

FIG. 4 shows a diagram illustrating techniques for ML-based transmission mode configuration and enablement based on a reinforcement learning framework, in accordance with certain aspects of the present disclosure.

FIG. 5 shows a flowchart illustrating an example process performable by or at a wireless node that supports ML-based transmission mode configuration and enablement, in accordance with certain aspects of the present disclosure.

FIG. 6 shows a block diagram of an example wireless communication device that supports ML-based transmission mode configuration and enablement, in accordance with certain aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Advanced transmission (TX) modes like Orthogonal Frequency Division Multiple Access (OFDMA), Multi-User Multiple Input Multiple Output (MU-MIMO), and Non-Primary Channel Access (NPCA) are key innovations in wireless communications standards (e.g., 802.11), aimed at improving efficiency and performance in dense environments.

OFDMA enables multiple users to share the same frequency band by dividing it into smaller sub-channels. This allows for more efficient resource allocation, as different users can transmit data on separate sub-carriers within the same time frame, minimizing latency and improving overall network throughput (e.g., especially in crowded settings with many devices).

MU-MIMO enhances data transmission by allowing multiple users to be served simultaneously through different spatial streams. In contrast to single-user MIMO (SU-MIMO), which serves one device at a time, MU-MIMO allows for parallel data transmission to multiple devices, reducing network congestion and improving bandwidth utilization (e.g., especially in environments with numerous connected devices where network capacity is critical for maintaining high speeds and low latency).

NPCA provides more flexibility when using multiple frequency bands for transmission. NPCA allows devices to transmit data on secondary channels even when the primary channel is busy, improving throughput in scenarios where spectrum resources are scarce.

Parameters related to Multi-User Enhanced Distributed Channel Access (MU-EDCA) facilitate managing medium access for different traffic types (e.g., voice, video, or background data) in multi-user environments. MU-EDCA ensures that high-priority traffic, such as voice or video, receives faster access to the medium, improving the quality of experience in networks where many devices compete for bandwidth.

There may be complexities involved with decision-making regarding enabling/disabling an advanced TX mode (e.g., OFDMA, MU-MIMO, NPCA, etc.) for downlink and/or uplink separately. There may also be complexities involved with configuring corresponding parameters (e.g., MU-EDCA) for an advanced TX mode. Such complexities may arise from TX mode implementation issues from the access point (AP) perspective and from the client/station (STA) perspective, and from the mixed effect of TX modes on a diverse set of clients and traffic. Conventional algorithms for making decisions regarding enabling or disabling these TX modes and configuring associated parameters work in some scenarios. However, conventional algorithms may be suboptimal in certain customer test scenarios and corner cases.

Aspects of the present disclosure provide techniques, including artificial intelligence (AI)/machine learning (ML) based techniques, that may be used to create policies for enabling/disabling advanced TX modes and configuring their operational parameters for a large diverse set of scenarios. Particular aspects of the subject matter described in this disclosure can be implemented to realize one or more potential advantages. In some examples, the described techniques may provide improved flexibility and capacity for optimization (e.g., based on various objective functions) when configuring/enabling/disabling advanced TX modes.

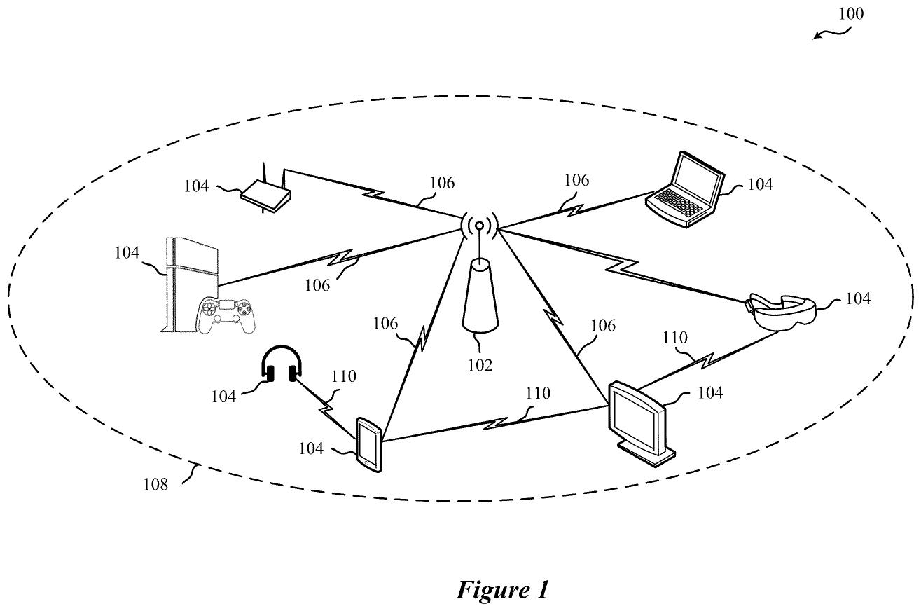

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some processes, methods, operations, techniques or other aspects described herein may be implemented, at least in part, using an artificial intelligence (AI) program. Such a program may include a machine learning (ML) or artificial neural network (ANN) model, hereinafter referred to generally as an AI/ML model (or just ML model).

One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may utilize mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QoS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some examples, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as AP 102s and STA 104s) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some examples, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

In some examples, an AI/ML model may be used for spatial reuse (SR) techniques and determinations. For example, a wireless communication device may exchange signaling to ascertain inputs to an AI/ML model and utilize an output of the AI/ML model to perform wireless communications in accordance with a SR procedure to improve the effectiveness of the SR procedure. For example, by using an AI/ML model (and in some aspects, shared observations and measurements from other devices as inputs to the AI/ML model), a transmitting device may more effectively generate SR parameters supporting SR transmissions, resulting in more effective use of available system resources, improved throughput, improved reliability, decreased latency, and better user experience. For example, a STA, an AP, or both, may use an AI/ML model to obtain one or more SR parameters, such as an overlapping basic service set (OBSS) preamble detection (PD) value, or a threshold of detected interference below which the device may transmit at a lower transmit power.

### Aspects Related to ML-Based TX Mode Configuration and Enablement

As noted above, there may be complexities involved with decision-making regarding enabling/disabling an advanced TX mode for downlink and/or uplink separately, and for configuring corresponding parameters. Such complexities may arise from TX mode implementation issues from the access point (AP) perspective and from the client/station (STA) perspective, and from the mixed effect of TX modes on a diverse set of clients and traffic. Conventional algorithms for making decisions regarding enabling or disabling these TX modes and configuring associated parameters work in some scenarios. However, conventional algorithms may be suboptimal in certain customer test scenarios and corner cases.

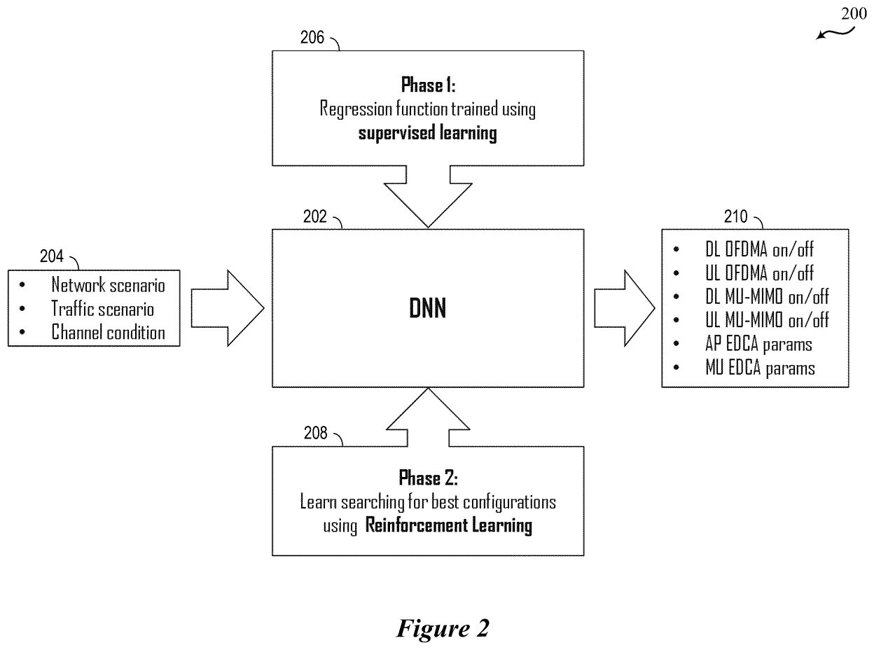

Aspects of the present disclosure provide techniques that may be used to create policies for enabling/disabling advanced TX modes and configuring their operational parameters for a large diverse set of scenarios. These techniques may be understood with reference to FIG. 2, which shows a diagram 200 illustrating techniques for ML-based transmission mode configuration and enablement, in accordance with certain aspects of the present disclosure.

As illustrated, an ML model (e.g., a deep neural network (DNN)) 202 may consider (e.g., take as input) information regarding a current transmission scenario. As illustrated at 204, for example, the DNN 202 may consider (e.g., current) network scenario/conditions, traffic scenario/conditions, and channel conditions.

In some aspects, the DNN may be trained based on one or more phases. For example, as illustrated at 206, the DNN may be based on a regression function trained using a supervised learning framework/algorithm (e.g., Phase 1 of training). As illustrated at 208, the DNN may be further trained to search/determine best (e.g., most optimal for a current transmission scenario) transmission configurations based on a reinforcement learning framework/algorithm.

As illustrated at 210, the DNN may output a best transmission configuration (e.g., indicating values for parameters associated with various advanced transmission modes) based on the information regarding a current transmission scenario 204. For example, the DNN may output a best transmission configuration indicating an on/off state for (each of) DL OFDMA, UL OFDMA, DL MU-MIMO, and UL MU-MIMO, and indicating values for various parameters associated with (AP and/or MU) EDCA.

According to certain aspects, a plurality of objective and sub-objective functions may be defined to optimize for various performance factors/metrics.

In some aspects, one or more sub-objective functions may be defined to optimize for various performance factors. For example, in some aspects, a default sub-objective function may be based on fairness and/or capacity. For such a fairness and/or capacity based sub-objective function, the value may drop significantly as fairness or capacity decreases. This may be represented by the following equation:

$$h ( λ ) = {\sum }_{i} {G}_{i} log \frac{{λ}_{i}}{max {r}_{i}} ,$$

where Gᵢ may set higher for multi-user (MU)-capable users, in order to weight MU-capable users higher.

Normalization may be performed for the fairness and/or capacity based sub-objective function, based on the following equation:

$$\hat{h} ( λ ) = max ( 0 , 1 + \frac{f ( d )}{B} ) ∼ ( 0 , 1 ) .$$

In some aspects, a sub-objective function may be based on a latency Service-Level Agreement (SLA). For such a latency SLA based sub-objective function, the value may drop significantly as delay increases. This may be represented by the following equation:

$$f ( d ) = 1 - {e}^{d / D} .$$

Normalization may be performed for the latency SLA based sub-objective function, based on the following equation:

$$\hat{f} ( d ) = E [ max ( 0 , 1 + \frac{f ( d )}{B} ) ] ∼ ( 0 , 1 ) .$$

In some aspects, a sub-objective function may be based on a throughput SLA. For such a throughput SLA based sub-objective function, the value may drop significantly as throughput decreases. This may be represented by the following equation:

$$g ( λ ) = ln ( λ / Λ ) .$$

Normalization may be performed for the throughput SLA based sub-objective function, based on the following equation:

$$\hat{g} ( λ ) = E [ \frac{min ( max ( LB , g ( λ ) ) , UB ) - LB}{UB - LB} ] ∼ ( 0 , 1 ) .$$

In some aspects, one or more joint objective functions may be defined. For example, a weight-based joint objective function may be defined, where different sub-objective functions are weighted differently based on their importance levels in the overall objective function. A weight-based joint objective function may be represented by the following equation:

$$obj = {w}_{f} \hat{f} ( {d}_{i = 1 , 2 , …} ) + {w}_{g} \hat{g} ( {λ}_{i = 1 , 2 , …} ) + {w}_{h} \hat{h} ( {λ}_{i = 1 , 2 , …} ) .$$

In some aspects, a precedence-based joint objective function may be defined, where objective functions may have conditional forms in order to give precedence to certain performance factors. A precedence-based joint objective function may be represented by the following equation:

$$obj = \{ \begin{matrix}\hat{f} ( {d}_{i = 1 , 2 , …} ) & if ∀ \frac{{d}_{i}}{{D}_{i}} > θ \\ \hat{g} ( {λ}_{i = 1 , 2 , …} ) & if ∀ \frac{{Λ}_{i}}{{λ}_{i}} > θ and all \frac{{d}_{i}}{{D}_{i}} > θ \\ \hat{h} ( {λ}_{i = 1 , 2 , …} ) & o . w .\end{matrix} .$$

As noted above, aspects of the present disclosure provide techniques for supervised learning based advanced transmission mode configuration. For example, as described above with reference to FIG. 2, a first phase (Phase 1) of (e.g., using and/or training) an ML model (e.g., a DNN) may be based on a supervised learning framework/algorithm.

According to aspects of the present disclosure, a supervised learning framework may be used for (e.g., training an ML model for) AI/ML-based transmission mode enablement/configuration. When supervised learning is used for training, the training may benefit from sampling as many scenarios as possible over time, and the objective function may be defined for optimizing transmission mode configurations based on various performance factors (as described above). In accordance with a supervised learning framework, the best configuration for each scenario may be determined by trying different configurations, where a neural network (NN) (e.g., an artificial NN (ANN) or a DNN) may be trained based on the best configurations for different sampled scenarios. When a scenario is very different from previously sampled scenarios, new configurations may be tried.

The features/inputs of a supervised learning framework for training an ML model for AI/ML-based transmission mode enablement/configuration may be associated with various scenario parameters. In some aspects, for example, features of the ML model may include client/traffic scenario parameters related to a quantity of clients (e.g., of certain capability(s)) and/or traffic profile (e.g., for a total quantity 6*16=96 features).

In some aspects, the parameters related to a quantity of clients of certain (e.g., advanced TX mode) capability may include parameters (e.g., 6 possibilities) indicating that a client is capable of:

$$SU only$$

$$SU + DL MU - MIMO only$$

$$SU + DL MU - MIMO + DL OFDMA only$$

$$SU + DL MU - MIMO + DL OFDMA + UL OFDMA only$$

$$SU + DL MU - MIMO + DL OFDMA + UL OFDMA + UL MU - MIMO only ,$$

$$or$$

$$SU + DL MU - MIMO + DL OFDMA + UL OFDMA + UL MU - MIMO + joint MU - MIMO - OFDMA$$

In some aspects, the parameters related to a traffic profile may include parameters (e.g., 16 possibilities) indicating whether:
Latency sensitive DL traffic is present (YES/NO)
Latency sensitive UL traffic is present (YES/NO)
Throughput sensitive DL traffic is present: (YES/NO), and
Throughput sensitive UL traffic is present: (YES/NO).

Additionally, features/inputs of the ML model may include channel scenario parameter(s) (e.g., a single (1) feature). For example, a feature of the ML model may be a parameter indicating an overlapping basic service set (OBSS) interference level (e.g., Low/Medium/High), which may be determined based on the following equation:

$$OBSS interference level = OBSS channel use / ( OBSS channel use + Idle Time ) .$$

The output(s) of the ML model may be a TX configuration indicating/including TX mode configuration parameter(s) (e.g., 6 total), MU EDCA parameter(s) (e.g., 4 total), and/or AP EDCA parameter(s) (e.g., 1 total), for a total of 11 (6+4+1) output parameters.

The TX Mode configuration parameters may include: DL OFDMA (on/off), UL OFDMA (on/off), DL MU-MIMO (on/off), UL MU-MIMO (on/off), DL Joint OFDMA/MU-MIMO (on/off), and/or UL Joint OFDMA/MU-MIMO (on/off) (e.g., for a total of 6 configuration outputs of the ML model).

The MU EDCA parameters may include an arbitration inter-frame space number (AIFSN) (which may take values indicating Aggressive/Regular/Relaxed), a minimum contention window (CWMin) (which may take values indicating Aggressive/Regular/Relaxed), a maximum contention window (CWMax) (which may take values indicating Aggressive/Regular/Relaxed), and/or an expiration time (e.g., which may take integer values indicating levels or a time duration). These MU EDCA output parameters may correspond to a total of 4 configuration outputs of the ML model (e.g., one output for each of the MU EDCA parameters described above).

The AP EDCA parameter(s) may include an EDCA parameter, which may take values of Aggressive or Regular, making a total of 1 configuration output of the ML model.

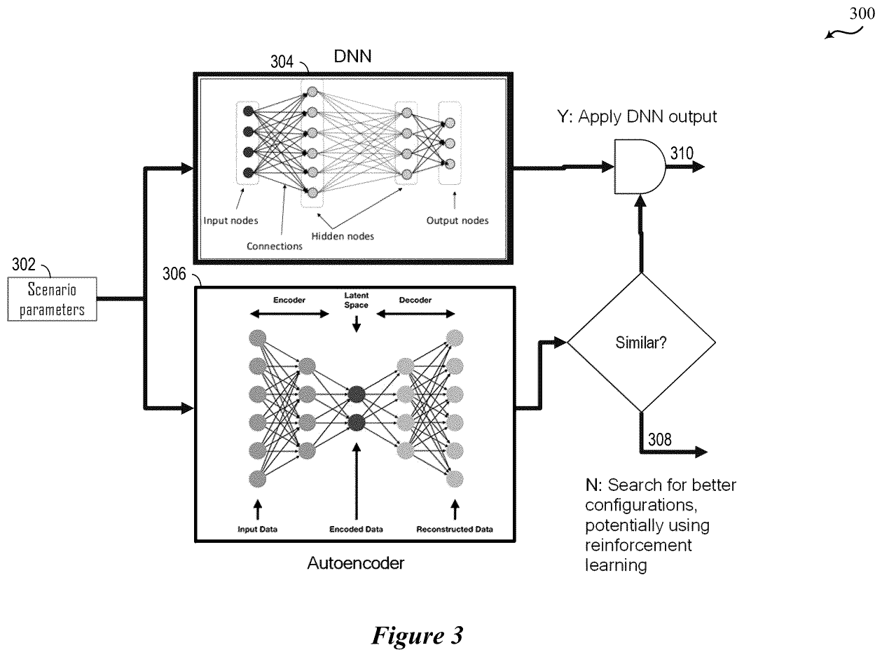

FIG. 3 shows a diagram 300 illustrating techniques for ML-based transmission mode configuration and enablement based on a supervised learning framework, in accordance with certain aspects of the present disclosure.

As illustrated, scenario parameters (e.g., the 97 features representing the scenario, described above) may be inputs to both a DNN 304 (e.g., which may be trained to predict the best configurations) and an autoencoder 306 (e.g., which may detect new scenarios that are very different from trained samples and trigger searching for better configurations).

The DNN 304 may include hidden layers/nodes (e.g., layer-1 may include 128 neurons and layer-2 may include 64 neurons) between the input nodes and the output nodes. The output of the DNN may be the configuration parameters/outputs (e.g., the 11 outputs relating to TX mode configuration parameter(s), MU EDCA parameter(s), and AP EDCA parameter(s) described above). In some aspects, the computation(s) performed by the DNN 304 may involve performing 2.0 million Multiply-Accumulate Operations (MACs) within a 10 ms time limit/budget, which may be repeated once every ten seconds.

In some aspects, the computation(s) performed by the autoencoder 306 may involve performing 2.0 million MACs within a 10 ms time limit/budget, which may be repeated once every ten seconds. As illustrated at 308, the autoencoder may output a similarity level/metric (e.g., or a difference level/metric) indicating a similarity/difference between trained samples and new input scenarios. In some aspects, the autoencoder may trigger searching for better configurations (e.g., using a reinforcement learning framework) based on the similarity/difference level output (e.g., if trained samples are not similar to a new input scenario).

As illustrated at 310, if the samples used for training are sufficiently similar (e.g., based on a similarity/difference level/metric compared to a threshold which may be configured) to a new input scenario, the TX configuration that is output by the DNN may be applied and used for transmission.

As noted above, aspects of the present disclosure provide techniques for reinforcement learning based advanced transmission mode configuration. For example, as described above with reference to FIG. 2, a second phase (Phase 2) of training/using an ML model (e.g., a DNN) may be based on a reinforcement learning framework/algorithm.

According to aspects of the present disclosure, a reinforcement learning framework may be used for (e.g., training a policy network/ML model for) AI/ML-based transmission mode enablement/configuration. The goal of the reinforcement learning framework may be to search for the best configurations in new scenarios (e.g., if trained samples are not similar to a new input scenario) as described above with reference to FIG. 3. In some aspects, the reinforcement learning framework may utilize Deep Q-Network (DQN) and/or Stochastic Policy Gradient (SPG) algorithms. The objective function may be defined for optimizing transmission mode configurations based on various performance factors (as described above).

The “episode” of the reinforcement learning framework may be defined as or characterized by a series of configuration adjustments within a few seconds. For example, an “episode” may start with an initial configuration for a scenario, and may include forward passing through the policy network to get a new configuration, and using the new configuration to run the network for a fixed time (e.g., 1 second). Then, a reward function and an updated state may be calculated, and forward passing through the policy network may resume again with the new/updated state and configuration until time runs out or the configuration is stabilized.

The “states” of the reinforcement learning framework may be defined as or characterized by the scenario (e.g., traffic), the (e.g., current) performance, remaining time (e.g., to stabilize a network configuration or to select a TX configuration), and/or the (e.g., current) configuration. The “actions” of the reinforcement learning framework may be defined as or characterized by the change of configuration (e.g., turn on OFDMA, reduce MU EDCA aggressiveness, etc.). The “rewards” of the reinforcement learning framework may be defined as or characterized by an objective function/performance change (e.g., an increase) which may be weighed by remaining time (e.g., to stabilize a network configuration or to select a TX configuration) and (e.g., significant) performance hit.

Training using the reinforcement learning framework may involve collecting a dataset of (state, action, reward) pairs from many episodes. In some aspects, each episode used for training may start from a different (scenario, initial configuration) pair, which may increase diversification and improve training. For each training step, a batch of collected episode data may be used to update the policy network/ML model.

In some aspects, the computation(s) performed by a policy network via a reinforcement learning framework (e.g., for an online forward pass) may involve performing 2.0 million Multiply-Accumulate Operations (MACs) within a 10 ms time limit/budget, which may be repeated once every second. Offline policy network updates of the reinforcement learning framework may involve double the computational steps and memory storage associated with online operations (e.g., online forward pass) of the reinforcement learning framework.

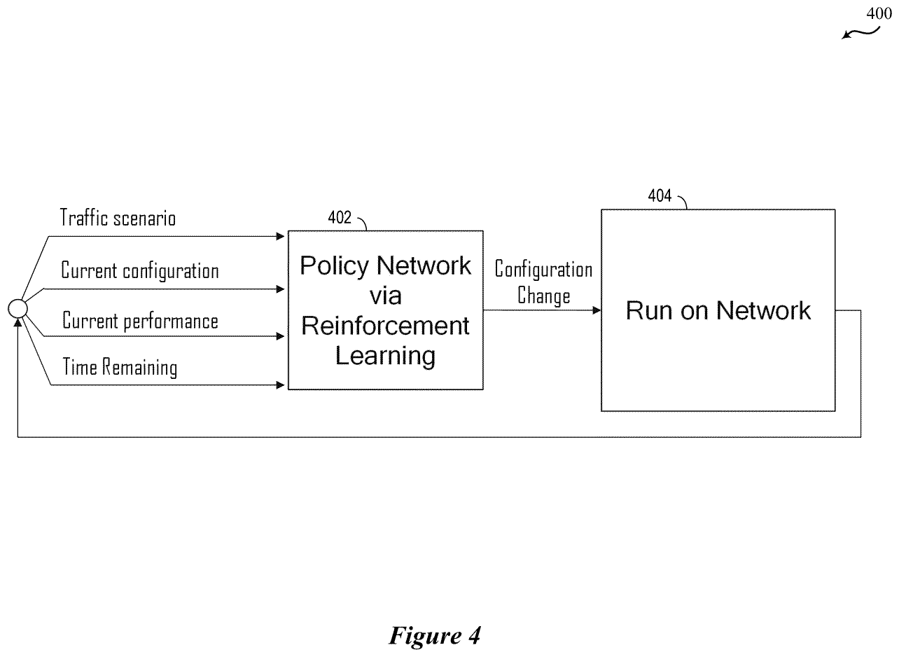

FIG. 4 shows a diagram 400 illustrating techniques for ML-based transmission mode configuration and enablement based on a reinforcement learning framework, in accordance with certain aspects of the present disclosure.

As illustrated, information regarding a (current) traffic scenario, a current configuration, current performance, and a time remaining (e.g., to stabilize a network configuration or to select a TX configuration) may be inputs to the policy network 402 (e.g., using a reinforcement learning framework). As illustrated at 404, the policy network may output a configuration change, which may then be used to run on the network. As illustrated, this process may be repeated/iterated for iterated changes in TX configurations based on new (current) inputs.

Particular aspects of the subject matter described in this disclosure can be implemented to realize one or more potential advantages. In some examples, the described techniques may provide improved flexibility and capacity for optimization (e.g., based on various objective functions) when configuring/enabling/disabling advanced TX modes.

### Example Operations

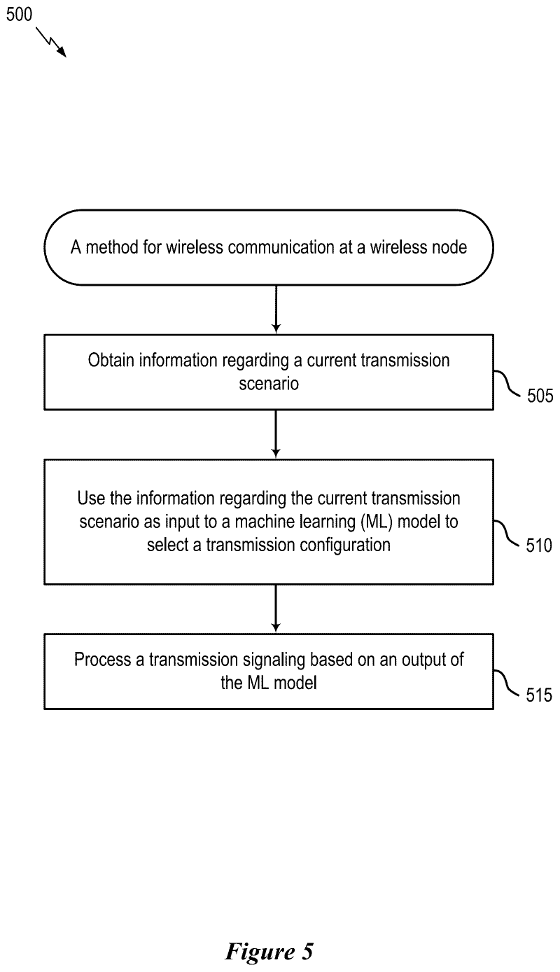

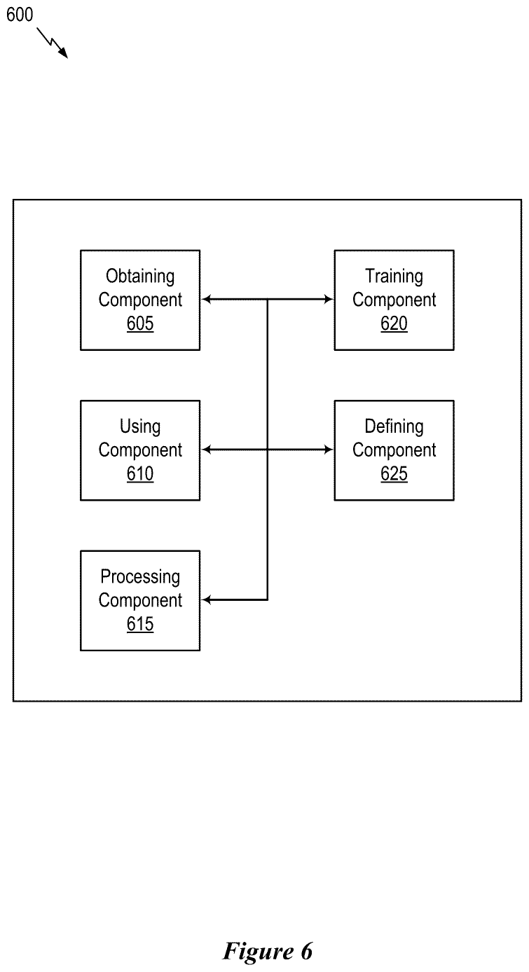

FIG. 5 shows a flowchart illustrating an example process 500 performable by or at a wireless node that supports ML-based transmission mode configuration and enablement. The operations of the process 500 may be implemented by a wireless STA, or its components as described herein, and/or wireless AP, or its components as described herein. For example, the process 500 may be performed by a wireless communication device, such as the wireless communication device 600 described with reference to FIG. 6, operating as or within a wireless STA or operating as or within a wireless AP. In some examples, the process 500 may be performed by a wireless STA such as one of the STAs 104 described with reference to FIG. 1. In some examples, the process 500 may be performed by a wireless AP such as one of the APs 102 described with reference to FIG. 1.

In some examples, in block 505, the wireless node may obtain information regarding a current transmission scenario. In some cases, the operations of this step refer to, or may be performed by, an obtaining component as described with reference to FIG. 6.

In some examples, in block 510, the wireless node may use the information regarding the current transmission scenario as input to a machine learning (ML) model to select a transmission configuration. In some cases, the operations of this step refer to, or may be performed by, a using component as described with reference to FIG. 6.

In some examples, in block 515, the wireless node may process a transmission based on an output of the ML model. In some cases, the operations of this step refer to, or may be performed by, a processing component as described with reference to FIG. 6.

In some aspects, the output of the ML model comprises the selected transmission configuration.

In some aspects, the transmission configuration is selected from a set of possible transmission configurations; and the set of possible transmission configurations is based on one or more capabilities of the wireless node.

In some aspects, the selected transmission configuration indicates one or more values for one or more parameters.

In some aspects, the one or more parameters comprise at least one of: a parameter indicating whether downlink (DL) orthogonal frequency division multiple access (OFDMA) is enabled; a parameter indicating whether uplink (UL) OFDMA is enabled; a parameter indicating whether DL multi-user (MU) multiple input multiple output (MIMO) is enabled; or a parameter indicating whether UL MU-MIMO is enabled.

In some aspects, the one or more parameters comprise at least one of: at least one access point (AP) enhanced distributed channel access (EDCA) parameter; or one or more multi-user (MU) EDCA parameters.

In some aspects, the information regarding the current transmission scenario comprises at least one of: a current transmission configuration, a performance associated with the current transmission configuration, one or more current channel characteristics, a remaining time to apply a transmission configuration, or information regarding one or more current traffic conditions.

In some aspects, the information regarding current traffic conditions indicates presence of at least one of: latency sensitive downlink traffic, latency sensitive uplink traffic, throughput sensitive downlink traffic, or throughput sensitive uplink traffic.

In some aspects, the process 500 further includes training the ML model based on: the information, and an objective function being based on a performance associated with one or more previous transmissions. In some cases, the operations of this step refer to, or may be performed by, a training component as described with reference to FIG. 6.

In some aspects, the ML model is trained based on samples of transmission scenario information associated with the one or more previous transmissions.

In some aspects, the ML model is trained using supervised learning based on a dataset of one or more transmission scenarios and one or more transmission configurations.

In some aspects, the ML model is trained using reinforcement learning based on: one or more states associated with one or more transmission scenarios, one or more actions associated with a switch from a current transmission configuration associated with a current state to the selected transmission configuration associated with a subsequent state, an episode associated with one or more of the actions in a time duration, and a reward associated with at least one of an improvement of performance resulting from the switch, whether a network failure has occurred, or a time remaining to stabilize a network configuration associated with the wireless node.

In some aspects, the process 500 further includes defining the objective function based on at least one of fairness, capacity, latency, throughput, weight, or precedence. In some cases, the operations of this step refer to, or may be performed by, a defining component as described with reference to FIG. 6.

In some aspects, the process 500 further includes using the ML model based on detection that a difference between information regarding one or more transmission scenarios used to train the ML model and the information regarding the current transmission scenario is at or below a threshold. In some cases, the operations of this step refer to, or may be performed by, a using component as described with reference to FIG. 6.

Note that FIG. 5 is just one example of a process, and other processes including fewer, additional, or alternative steps are possible consistent with this disclosure.

### Example Communications Device(s)

FIG. 6 shows a block diagram of an example wireless communication device 600 that supports ML-based transmission mode configuration and enablement. In some examples, the wireless communication device 600 is configured to perform the process 500 described with reference to FIG. 5. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 600 may transmit the information output from the chip. In such an example, the second interface may refer to an interface between the processing system of the chip and a reception component, such that the device 600 may receive information that is passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in a STA, such as the STA 104 described with reference to FIG. 1. In some other examples, the wireless communication device 600 can be a STA that includes such a processing system and other components including multiple antennas. In some examples, the wireless communication device 600 can be configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system. In some examples, the wireless communication device 600 further includes at least one external network interface coupled with the processing system that enables communication with a core network or backhaul network that enables the wireless communication device 600 to gain access to external networks including the Internet.

The wireless communication device 600 includes obtaining component 605, using component 610, processing component 615, training component 620, and defining component 625. Portions of one or more of the components 605, 610, 615, 620, and 625 may be implemented at least in part in hardware or firmware. For example one or more of the components 605, 610, 615, 620, and 625 may be implemented at least in part by a processor or a modem. In some examples, portions of one or more of the components 605, 610, 615, 620, and 625 may be implemented at least in part by a processor and software in the form of processor-executable code stored in a memory.

### Example Clauses

Implementation examples are described in the following numbered clauses:

Clause 1: A method for wireless communication at a wireless node, including: obtaining information regarding a current transmission scenario; using the information regarding the current transmission scenario as input to a machine learning (ML) model to select a transmission configuration; and processing a transmission based on an output of the ML model.

Clause 2: The method of Clause 1, where the output of the ML model includes the selected transmission configuration.

Clause 3: The method any one of Clauses 1-2, where the transmission configuration is selected from a set of possible transmission configurations; and the set of possible transmission configurations is based on one or more capabilities of the wireless node.

Clause 4: The method any one of Clauses 1-3, where the selected transmission configuration indicates one or more values for one or more parameters.

Clause 5: The method of Clause 4, where the one or more parameters include at least one of: a parameter indicating whether downlink (DL) orthogonal frequency division multiple access (OFDMA) is enabled; a parameter indicating whether uplink (UL) OFDMA is enabled; a parameter indicating whether DL multi-user (MU) multiple input multiple output (MIMO) is enabled; or a parameter indicating whether UL MU-MIMO is enabled.

Clause 6: The method of Clause 4, where the one or more parameters include at least one of: at least one access point (AP) enhanced distributed channel access (EDCA) parameter; or one or more multi-user (MU) EDCA parameters.

Clause 7: The method any one of Clauses 1-6, where the information regarding the current transmission scenario includes at least one of: a current transmission configuration, a performance associated with the current transmission configuration, one or more current channel characteristics, a remaining time to apply a transmission configuration, or information regarding one or more current traffic conditions.

Clause 8: The method of Clause 7, where the information regarding current traffic conditions indicates presence of at least one of: latency sensitive downlink traffic, latency sensitive uplink traffic, throughput sensitive downlink traffic, or throughput sensitive uplink traffic.

Clause 9: The method any one of Clauses 1-8, further including: training the ML model based on: the information, and an objective function being based on a performance associated with one or more previous transmissions.

Clause 10: The method of Clause 9, where the ML model is trained based on samples of transmission scenario information associated with the one or more previous transmissions.

Clause 11: The method of Clause 9, where the ML model is trained using supervised learning based on a dataset of one or more transmission scenarios and one or more transmission configurations.

Clause 12: The method of Clause 9, where the ML model is trained using reinforcement learning based on: one or more states associated with one or more transmission scenarios, one or more actions associated with a switch from a current transmission configuration associated with a current state to the selected transmission configuration associated with a subsequent state, an episode associated with one or more of the actions in a time duration, and a reward associated with at least one of an improvement of performance resulting from the switch, whether a network failure has occurred, or a time remaining to stabilize a network configuration associated with the wireless node.

Clause 13: The method of Clause 9, further including: defining the objective function based on at least one of fairness, capacity, latency, throughput, weight, or precedence.

Clause 14: The method any one of Clauses 1-13, further including: using the ML model based on detection that a difference between information regarding one or more transmission scenarios used to train the ML model and the information regarding the current transmission scenario is at or below a threshold.

Clause 15: The method of any one of Clauses 1-14, further including: also using one or more configurations, which are configured independent of the ML model, as input to the ML model to select the transmission configuration.

Clause 16: An apparatus, including: at least one memory including executable instructions; and at least one processor configured to execute the executable instructions to cause the apparatus to perform a method in accordance with any combination of Clauses 1-15.

Clause 17: An apparatus, including means for performing a method in accordance with any combination of Clauses 1-15.

Clause 18: A non-transitory computer-readable medium including executable instructions that, when executed by at least one processor of an apparatus, cause the apparatus to perform a method in accordance with any combination of Clauses 1-15.

Clause 19: A computer program product embodied on a computer-readable storage medium including code for performing a method in accordance with any combination of Clauses 1-15.

Clause 20: A wireless node (e.g., a wireless STA or an AP), including: at least one transceiver; at least one memory including executable instructions; and at least one processor configured to execute the executable instructions to cause the wireless node to perform a method in accordance with any combination of Clauses 1-15, wherein the at least one transceiver is configured to receive the information regarding the current transmission scenario.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

Means for obtaining, means for using, means for processing, means for training, and means for defining may comprise one or more processors, such as the one or more processors described above with reference to FIG. 6.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions to cause the apparatus to:
obtain information regarding a current transmission scenario;
use the information regarding the current transmission scenario as input to a machine learning (ML) model to select a transmission configuration; and
process a transmission based on an output of the ML model.

2. The apparatus of claim 1, wherein:
the output of the ML model comprises the selected transmission configuration.

3. The apparatus of claim 1, wherein:
the transmission configuration is selected from a set of possible transmission configurations the set of possible transmission configurations is based on one or more capabilities of the apparatus.

4. The apparatus of claim 1, wherein:
the selected transmission configuration indicates one or more values for one or more parameters.

5. The apparatus of claim 4, wherein the one or more parameters comprise at least one of:
a parameter indicating whether downlink (DL) orthogonal frequency division multiple access (OFDMA) is enabled;
a parameter indicating whether uplink (UL) OFDMA is enabled;
a parameter indicating whether DL multi-user (MU) multiple input multiple output (MIMO) is enabled; or
a parameter indicating whether UL MU-MIMO is enabled.

6. The apparatus of claim 4, wherein the one or more parameters comprise at least one of: at least one access point (AP) enhanced distributed channel access (EDCA) parameter; or one or more multi-user (MU) EDCA parameters.

7. The apparatus of claim 1, wherein the information regarding the current transmission scenario comprises at least one of:
a current transmission configuration,
a performance associated with the current transmission configuration,
one or more current channel characteristics,
a remaining time to apply a transmission configuration, or
information regarding one or more current traffic conditions.

8. The apparatus of claim 7, wherein the information regarding current traffic conditions indicates presence of at least one of:
latency sensitive downlink traffic,
latency sensitive uplink traffic,
throughput sensitive downlink traffic, or
throughput sensitive uplink traffic.

9. The apparatus of claim 1, wherein the one or more processors are further configured to cause the apparatus to train the ML model based on:
the information, and
an objective function being based on a performance associated with one or more previous transmissions.

10. The apparatus of claim 9, wherein the ML model is trained based on samples of transmission scenario information associated with the one or more previous transmissions.

11. The apparatus of claim 9, wherein the ML model is trained using supervised learning based on a dataset of one or more transmission scenarios and one or more transmission configurations.

12. The apparatus of claim 9, wherein the ML model is trained using reinforcement learning based on:
one or more states associated with one or more transmission scenarios,
one or more actions associated with a switch from a current transmission configuration associated with a current state to the selected transmission configuration associated with a subsequent state,
an episode associated with one or more of the actions in a time duration, and
a reward associated with at least one of an improvement of performance resulting from the switch, whether a network failure has occurred, or a time remaining to stabilize a network configuration associated with the apparatus.

13. The apparatus of claim 9, wherein the one or more processors are further configured to cause the apparatus to:
define the objective function based on at least one of fairness, capacity, latency, throughput, weight, or precedence.

14. The apparatus of claim 1, wherein the one or more processors are further configured to cause the apparatus to:
use the ML model based on detection that a difference between information regarding one or more transmission scenarios used to train the ML model and the information regarding the current transmission scenario is at or below a threshold.

15. The apparatus of claim 1, wherein the one or more processors are further configured to cause the apparatus to:
also use one or more configurations, that are configured independent of the ML model, as input to the ML model to select the transmission configuration.

16. A method for wireless communication at a wireless node, comprising:
obtaining information regarding a current transmission scenario;
using the information regarding the current transmission scenario as input to a machine learning (ML) model to select a transmission configuration; and
processing a transmission based on an output of the ML model.

17. The method of claim 16, wherein the output of the ML model comprises the selected transmission configuration.

18. The method of claim 16, wherein:
the transmission configuration is selected from a set of possible transmission configurations; and
the set of possible transmission configurations is based on one or more capabilities of the wireless node.

19. The method of claim 16, wherein the selected transmission configuration indicates one or more values for one or more parameters.

20. A wireless node, comprising:
at least one transceiver;
at least one memory comprising computer-executable instructions; and
one or more processors configured to execute the computer-executable instructions to cause the wireless node to:
receive, via the at least one transceiver, information regarding a current transmission scenario;
use the information regarding the current transmission scenario as input to a machine learning (ML) model to select a transmission configuration; and
process a transmission based on an output of the ML model.
